(19) United States
(12) Patent Application Publication
(10) Pub. No.: US 2025/0179277 A1
(43) Pub. Date: Jun. 5, 2025

(54) PRESSED PRODUCTS MADE OF A CROSSLINKABLE MATERIAL, METHOD FOR THE PRODUCTION AND FURTHER PROCESSING THEREOF TO PRODUCE ELASTOMER-BASED MOULDED BODIES

(71) Applicants: Evonik Operations GmbH, Essen (DE); Forward Engineering GmbH, Muenchen (DE)

(72) Inventors: Alexander Paasche, Haltern am See (DE); Manfred Nagel, Reken (DE); Kirsten Alting, Muenster (DE); Robert Maier, Muenchen (DE); Tim Buschulte, Muenchen (DE)

(73) Assignees: Evonik Operations GmbH, Essen (DE); Forward Engineering GmbH, Muenchen (DE)

(21) Appl. No.: 18/842,072

(22) PCT Filed: Feb. 14, 2023
(86) PCT No.: PCT/EP2023/053562

§ 371 Date: Aug. 28, 2024

(30) Foreign Application Priority Data
Mar. 3, 2022 (EP) 22159862.6

(51) Int. Cl. C08L 17/00; B29C 43/00; B29C 43/52; B29K 21/00; B29K 23/00; B29K 105/00; B29K 105/26; B29K 507/00; B29K 509/02; C08L 9/06

(52) U.S. Cl. CPC C08L 17/00; B29C 43/003; B29C 43/006; B29C 43/52; C08L 9/06; B29K 2021/003; B29K 2023/18; B29K 2105/0005; B29K 2105/26; B29K 2507/00; B29K 2509/02; B29K 2995/0063; B29K 2995/0078; B29K 2995/0094; C08L 2207/24; C08L 2312/00

(57) ABSTRACT

Compacts synthesized by cross-linkable material based on an elastomer-containing powder or pelletized material and a method for producing these compacts show a very good suitability in the further processing of these compacts to form crosslinked elastomer compounds and shaped bodies and for the substitution of raw rubber or raw rubber-containing compositions.

The present invention relates to a method for producing compacts composed of a crosslinkable material based on an elastomer-containing powder or pelletized material, in particular composed of recycled material such as used tyres, to the compacts obtainable from said method and to the further processing thereof, particularly in methods for producing elastomer compounds and shaped bodies formed therefrom. The compacts according to the invention are of very good suitability for the substitution of raw rubber or raw rubber-containing compositions in existing value chains.

### TECHNICAL BACKGROUND

Rubber-elastic products are conventionally produced by shaping and crosslinking of highly viscous formulations based on crosslinkable materials such as raw rubber. In principle, elastomer-based powders or pelletized materials can also be processed to form rubber-elastic products by way of compression. Powders or pelletized materials such as those obtained in the recycling of used elastomer materials, for example used tyres, can be used here, this being desirable for reasons of sustainability. With a volume of around 1000 million used tyres that arise worldwide per year, used tyres represent a major environmental problem and at the same time a great economic potential for recycling opportunities, cf. for instance K. Formela “Sustainable development of waste tires recycling technologies—recent advances, challenges and future trends”, Advanced Industrial and Engineering Polymer Research 4 (2021), 209-222

However, elastomer-based powders or pelletized materials generally consist of a plurality of individual particles of an already crosslinked elastomeric material. The product properties, such as material cohesion, mechanical properties or resistance to ageing, are therefore often comparatively poor when producing rubber-elastic products from elastomer-based powders or pelletized materials, and the resulting products consequently have restricted usability. In addition, elastomer-based powders or pelletized materials generally have a low bulk density that is significantly (for example by a factor of 2-4) below the density of the rubber-elastic products to be manufactured. In contrast, raw rubber has a density similar to that of the final product. Therefore, when using elastomer-based powders or pelletized materials to manufacture rubber-elastic products, tools used for processing raw rubber-based feed materials, such as by way of compression moulding or transfer moulding, can usually be used only with difficulty, if at all, and there is instead a need for specially made tools that are designed for a relatively large reduction in volume in the processing operation. The handling and metering of elastomer-based powders or pelletized materials in the manufacturing process are additionally more complex compared with raw rubber-based feed materials and not compatible with existing equipment in raw rubber-based processing operations. These factors therefore hinder a substitution, that is desirable for reasons of sustainability and cost, of raw rubber or raw rubber-containing compositions by elastomer-based powders or pelletized materials in existing value chains

The present invention is therefore based on the object of providing means and procedures for using elastomer-based powders or pelletized materials for the production of rubber-elastic products, which at least partially reduce or eliminate the above-described disadvantages of the prior art. In particular, the means and procedures should be implementable in a cost-effective and efficient manner enabling the use of recycled materials that are available on a large scale, such as pelletized used tyres, enable a simple substitution of raw rubber or raw rubber-containing compositions by elastomer-based powders or pelletized materials in existing value chains and enable production of rubber-elastic products having product properties that are able to satisfy even relatively demanding applications.

### SUMMARY OF THE INVENTION

The underlying object is achieved according to the invention by a method for producing a compact composed of a crosslinkable material as defined in appended independent claim 1 and the compacts obtainable by this method. The method comprises.
(a) providing a mixture comprising:
   (i) a powder or pelletized material comprising at least one elastomer, and
   (ii) one or more additives comprising at least one solid binder having a melting or softening temperature (Tm) in the range of 100° C. or less, and ethylenically unsaturated functional groups,
(b) compacting the mixture, that has been heated to a temperature of less than 120° C., using a shaping tool to form a compact, and
(c) demoulding the compact, after cooling, at a temperature of less than Tm in order to obtain the compact composed of a crosslinkable material.

In addition, the invention relates to a method for producing shaped bodies using the compacts according to the invention. The method may comprise providing a compact composed of a crosslinkable material described herein, and crosslinking the crosslinkable material to form a crosslinked elastomer compound. The method for producing a shaped body may also comprise the following steps:
(a) providing a feed material for a shaping tool, wherein the feed material comprises at least one compact composed of a crosslinkable material described herein or one or more parts thereof,
(b) shaping the feed material using the shaping tool to form a desired shape, and
(c) crosslinking the feed material to form a crosslinked elastomer compound.

The invention further relates to shaped bodies and articles comprising a crosslinked elastomer compound that are obtainable by this method.

Furthermore, the invention is directed to the use of a compact composed of a crosslinkable material, as described herein, or of one or more parts thereof, for the production of an article comprising a crosslinked elastomer compound and/or for the substitution of raw rubber or raw rubber-containing compositions.

The compacts according to the invention can be produced in a cost-effective and efficient manner using commercially available starting materials and existing technology from the field of powder processing. Use may be made here of high proportions, for example 70% by weight or more, based on the total weight of the compact, of recycled materials that are available on a large scale, such as pelletized used tyres. The compacts produced according to the invention generally have a significantly higher density than the bulk density of the starting mixture and can therefore be stored and transported in a space-saving and cost-saving manner. Compacts having good material cohesion and high strength can be produced. The compacts according to the invention can easily be handled and processed further using common equipment for raw rubber-based processing operations, without any need for specially made tools for this purpose. In the compacts according to the invention, the particles of the elastomer-based powder or pelletized material may be in activated form for crosslinking. The compacts may serve as ready-to-use intermediate (masterbatch) that can be effectively processed further to form crosslinked elastomer compounds and shaped bodies formed therefrom. The resulting rubber-elastic products may have product properties that satisfy even relatively demanding applications. The compacts according to the invention therefore promote a substitution, that is desirable for reasons of sustainability and cost, of raw rubber or raw rubber-containing compositions by elastomer-based powders or pelletized materials in existing value chains

### FIGURES

FIG. 1a shows a photograph of the material after the attempted production of a compact from a powder composed of used tyres in accordance with Example 1 (comparative example).

FIG. 1b shows a photograph of the compact obtained in accordance with Example 2 (comparative example), after falling from a height of 2 m.

FIG. 1c shows a photograph of a compact according to the present invention obtained in accordance with Example 3, after falling from a height of 2 m.

FIG. 1d shows a photograph of a compact according to the present invention obtained in accordance with Example 4, after falling from a height of 2 m.

### DETAILED DESCRIPTION OF THE INVENTION

As described above, the invention relates to compacts composed of a crosslinkable material and to a method for the production thereof. To produce a compact composed of a crosslinkable material, according to the present invention as described above a mixture comprising, inter alia, an elastomer-containing powder or pelletized material is provided. A “powder” or “pelletized material” should in each case be understood here to mean a solid present in the form of a plurality of fine particles. These particles can typically move freely with respect to one another when the powder or pelletized material is agitated. The powder or pelletized material used in the context of the present invention is typically free-flowing. A “pelletized material” in the context of the present description here differs from a powder by the dimensions of the particles. Accordingly, reference is made herein to a “powder” when the particles have dimensions in the sub-millimetre range. In contrast, a “pelletized material” means particulate solids comprising larger particles having dimensions of >1 mm. Alternative terms such as “meal” (for example “rubber meal”) or “grit” are sometimes used among experts to refer to pulverulent or granular material. Regardless of such an alternative name, such materials should also be regarded as powder or pelletized material in the sense of the present disclosure and can be used as such.

The powder or pelletized material used according to the invention comprises at least one elastomer. An “elastomer” is understood here to mean an elastically deformable polymer material. Elastomers are therefore dimensionally stable but elastic and return to their original shape again after deformation, i.e. have rubber-elastic properties. Examples of elastomers that the powder or pelletized material used according to the invention may comprise are, for instance, elastomers that are obtainable by wide-mesh crosslinking (also referred to as vulcanization) of natural rubber or synthetic rubber and also referred to as rubber materials, and thermoplastic elastomers. For example, the at least one elastomer may therefore comprise a crosslinked natural rubber, a crosslinked synthetic rubber, a thermoplastic elastomer or a mixture or combination thereof. Natural rubber is obtained from the latex of the rubber tree (Hevea brasiliensis) and consists predominately of cis-1,4-polyisoprene. Examples of synthetic rubbers include, for instance, ethylene-propylene-diene rubbers (EPDM), styrene-diolefin rubbers, such as styrene-butadiene rubber (SBR), polybutadiene rubber, polyisoprene, styrene-isoprene rubber, butadiene-isoprene rubber, butyl rubber, such as isobutene-isoprene rubber, halobutyl rubber, such as chloro- or bromobutyl rubber, nitrile rubber, hydrogenated nitrile rubber, carboxylated butadiene-acrylonitrile rubber, styrene-butadiene-acrylonitrile rubber, carboxylated styrene-butadiene rubber, silicone rubber, polychloroprene and epoxidized natural rubber. Examples of thermoplastic elastomers include, for instance, thermoplastic polyamide elastomers, thermoplastic polyester elastomers, olefin-based thermoplastic elastomers, such as PP/EPDM, thermoplastic styrene block copolymers, and urethane-based thermoplastic elastomers.

The powder or pelletized material may comprise the at least one elastomer in an amount corresponding to at least 30% by weight, for example around at least 35% by weight or at least 40% by weight, or at least 50% by weight, based on the total weight of the powder or pelletized material. The powder or pelletized material may comprise up to 100% by weight of the at least one elastomer (i.e. consist of it in the case of 100%), for example 90% by weight or less, 80% by weight or less, 70% by weight or less, or 60% by weight or less, based on the total weight of the powder or pelletized material. The proportion of the elastomer may be in a range formed by any desired combination of abovementioned values, for example of 30% by weight to 100% by weight, or of 40% by weight to 80% by weight. The powder or pelletized material typically comprises at least 40% by weight, for instance 40% to 70% by weight, of the at least one elastomer, based on the total weight of the powder or pelletized material.

The powder or pelletized material used according to the invention may preferably comprise at least one recycled elastomer. “Recycled elastomer” should be understood here to mean an elastomer which has already been used in a product and is recovered from this product, typically at the end of its intended use. For example, the recycled elastomer may comprise any one of the abovementioned elastomers or a mixture or combination thereof, for instance in the abovementioned amounts. The product from which the recycled elastomer is recovered may be any desired elastomer-containing product or part or material thereof. Illustrative examples include, for instance, used tyres (such as car tyres, truck tyres, off-road tyres), or parts thereof, such as tyre treads or sidewalls, used conveyor belts, seals, shoe soles or other elastomer products. The powder or pelletized material used according to the invention is preferably provided by a method for recycling used tyres or parts thereof.

Used tyre materials and methods for the recycling thereof are summarized, for instance, in K Formela “Sustainable development of waste tires recycling technologies—recent advances, challenges and future trends”, Advanced Industrial and Engineering Polymer Research 4 (2021), 209-222. To recycle used tyres, steel and fabric components are usually removed first and then the used tyre (part) to be recycled, after mechanical coarse comminution, is ground into a powder or pelletized material by grinding either at ambient temperature or cryogenically with nitrogen cooling. Other methods use comminution by means of water jets, for instance. Powders and pelletized materials obtained by recycling used tyres (used tyre parts) (also referred to as “ground tyre rubber” (GTR)) are commercially available from a multiplicity of suppliers such as MRH GmbH, Genan GmbH or Roth International GmbH, at a fraction of the cost associated with the original production of corresponding elastomers.

As is known to those skilled in the art, powders or pelletized materials obtained from elastomer-containing products such as used tyres by way of a recycling process may comprise, in addition to the elastomer component, further constituents that are separated only partially, if at all, from the elastomer component during the recycling process. These further constituents may comprise any ingredients that are usually used in the recycled products or materials in addition to the elastomer component, for example residues of the agents used for the crosslinking of the elastomer, processing aids and/or additives such as pigments or fillers. Powders or pelletized materials from recycling of used tyres thus usually comprise not insignificant amounts of fillers such as carbon black and/or silica, and residues of the agents used for the crosslinking of the elastomer The powder or pelletized material may for example comprise further constituents different from the elastomer component in an amount of up to 70% by weight, for instance 65% by weight or less, or 60% by weight or less, or 50% by weight or less, based on the total weight of the powder or pelletized material. The powder or pelletized material may comprise further constituents different from the elastomer component for example in an amount of 10% by weight or more, or 20% by weight or more, or 30% by weight or more, or 40% by weight or more, based on the total weight of the powder or pelletized material. The proportion of the further constituents different from the elastomer component, if present, may be in a range formed by any desired combination of abovementioned values, for example of 10% by weight to 70% by weight, or of 20% by weight to 60% by weight.

The size of the particles in the powders or pelletized materials may be set as desired. This may be performed advantageously for instance by fractionation by means of sieves using a successive arrangement of sieves having different mesh sizes. Particles having dimensions larger than a sieve opening defined by the mesh size are retained by the corresponding sieve, and particles having smaller dimensions pass through the corresponding sieve. For example, the powders or pelletized materials used according to the invention may have a particle size of 5 mesh (4.0 mm) or less, or of 10 mesh (1.7 mm) or less, or of 16 mesh (1.0 mm) or less, or of 20 mesh (0.84 mm) or less, or of 24 mesh (0.71 mm) or less, or of 28 mesh (0.60 mm) or less, or of 32 mesh (0.50 mm). For example, the powders or pelletized materials used according to the invention may have a particle size of 150 mesh (0.105 mm) or more, or of 115 mesh (0.125 mm) or more, or of 100 mesh (0.149 mm) or more, or of 80 mesh (0.18 mm) or more, or of 65 mesh (0.21 mm) or more, or of 60 mesh (0.25 mm) or more, or of 48 mesh (0.30 mm) or more, or of 42 mesh (0.35 mm) or more, or of 35 mesh (0.42 mm) or more. The powders or pelletized materials may have a particle size that is in a range formed by any desired combination of abovementioned values, for example of 150 mesh (0.105 mm) to 5 mesh (4.0 mm), or of 115 mesh (0.125 mm) to 20 mesh (0.84 mm), or of 65 mesh (0.21 mm) to 35 mesh (0.42 mm), or of 32 mesh (0.50 mm) to 10 mesh (1.7 mm). The above details relate to sieves from the Tyler standard series (cf., for instance, Chemiker-Kalender, H. U. von Vogel, Springer Verlag, 1956).

In the mixture provided according to the invention for producing the compacts, use may be made of an elastomer-containing powder or pelletized material as described in more detail above, or a mixture or combination of one or more elastomer-containing powders with one or more elastomer-containing pelletized materials, or a mixture or combination of two or more elastomer-containing powders or a mixture or combination of two or more elastomer-containing pelletized materials.

The elastomer-containing powder and/or pelletized material usually constitutes the quantitatively predominant component of the mixture. The mixture may thus comprise the elastomer-containing powder and/or pelletized material for example in an amount corresponding to 50% by weight or more, or 60% by weight or more, or 70% by weight or more, or 75% by weight or more, or 80% by weight or more, or 85% by weight or more, or 90% by weight or more, based on the total weight of the mixture. The elastomer-containing powder and/or pelletized material may for example be present in the mixture in an amount of 99% by weight or less, or of 95% by weight or less, or of 90% by weight or less, or of 85% by weight or less, based on the total weight of the mixture. The proportion of the elastomer-containing powder and/or pelletized material may be in a range formed by any desired combination of abovementioned values, for example of 50% by weight to 95% by weight, or of 60% by weight to 85% by weight.

In addition to the elastomer-containing powder or pelletized material described above, the mixture used to produce compacts composed of a crosslinkable material according to the present invention comprises one or more additives. The one or more additives here comprise at least one binder

The at least one binder is solid, i.e. it is in solid form under standard conditions (20° C., 101.3 kPa). The binder may be characterized by its thermal properties and in particular feature a relatively low melting or softening temperature (Tₘ). The binder thus has a melting or softening temperature of 100° C. or less. For example, the binder may have a melting or softening temperature of 90° C. or less, or of 80° C. or less, or of 70° C. or less, or of 60° C. or less. For example, the binder may have a melting or softening temperature of 20° C. or more, or 30° C. or more, or of 35° C. or more, or of 40° C. or more, or of 45° C. or more, or of 50° C. or more. The melting or softening temperature may be in a range formed by any desired combination of abovementioned values, for example in the range of 30° C. to 100° C., for instance in the range of 40° C. to 100° C., for instance of 40° C. to 90° C., or of 50° C. to 80° C. or of 50° C. to 70° C. The binder preferably has a melting or softening temperature of 80° C. or less, more preferably of 70° C. or less, for instance in the range of 30° C. to 70° C. The melting temperature refers to the temperature at which a substance is converted from a solid to a liquid physical state at atmospheric pressure (101.3 kPa). Softening temperature (also called glass transition temperature) means the temperature at which a substance (for example amorphous polymer) is converted from a solid, glassy, brittle state to a softened, flexible state at atmospheric pressure (101.3 kPa). The melting temperature of the binder may be determined by means of differential scanning calorimetry in accordance with DIN EN ISO 11357-3, the melting point usually being regarded as the measurement result after the second heating run, and a heating-cooling rate of 20° C./min being used. The softening temperature of the binder may be determined by means of differential scanning calorimetry in accordance with DIN EN ISO 11357-2. A relatively low melting or softening temperature, as described above, means that the binder can be converted into a soft and/or flowable state relatively easily by applying pressure and/or heating. The binder can therefore easily be converted, for example before or during a mixing operation for producing the mixture used according to the invention, into a soft and/or flowable state, as a result of which a dispersion, wetting, swelling, and activation of the elastomer-containing powders or pelletized materials can be promoted. Where a transition occurs, this is generally reversible, and so the softened/flowable binder can be converted back into a solid state by reducing the pressure and/or cooling, and the binder can thus contribute to the strength and the material cohesion of the compacts according to the invention

Binders used according to the invention may be binders of a type known per se. For example, the binder may comprise a thermoplastic polymer, a resin, an ionomer, a wax, or a mixture or combination thereof. Such binders can be produced in a known manner and are commercially available. Examples of thermoplastic polymers include, for instance, ethylene-vinyl acetate (EVA) copolymers, polystyrene, polyesters such as polyethylene terephthalate, polycarbonates, polyamides, acrylic polymers, polyurethanes, diene-based polymers such as acrylic-butadiene-styrene (ABS), polybutadienes and liquid rubbers, and particularly polyolefins such as polyethylene, propylene and copolymers based thereon. Examples of suitable resins include, for instance, natural resins such as rosin, tall resins or tall oil pitch. Ionomers can be produced by copolymerization of nonpolar or low-polarity monomers with monomers having ionizable functional groups. The ionizable functional groups lead to ionic bonds between the polymer molecules. Examples of ionomers are commercially available, for instance, under the trade names Surlyn® or Nucrel® from DuPont or Eltex® from Ineos. Examples of waxes that can be used as binder are, for instance, paraffinic waxes.

The one or more additives further comprise ethylenically unsaturated functional groups. The one or more additives therefore comprise at least one ethylenically unsaturated compound. “Ethylenically unsaturated” herein means that the functional groups or compounds specified thereby have one or more carbon-carbon multiple bond(s), such as C═C double bonds and/or C═C triple bonds. The ethylenically unsaturated functional groups introduced by the additive component serve for the crosslinkabilty of the material and can activate the particles of the elastomer-containing powder or pelletized material with respect to crosslinking and can promote crosslinking, particularly by formation of covalent bonds, between various particles of the elastomer-containing powder or pelletized material. It is possible here for the at least one binder to comprise one or more ethylenically unsaturated functional groups, i.e. binder functionality and ethylenically unsaturated functional groups can be united in one component. Alternatively, the at least one binder used does not comprise any crosslinkable ethylenically unsaturated functional groups. In this case, one or more ethylenically unsaturated compounds are used in addition to the binder. These ethylenically unsaturated compounds may in particular be ethylenically unsaturated low molecular weight (molecular weight <500 g/mol) oligomeric or monomeric organic compounds. Examples are, for instance, substances usually used as monomers or reactive diluents, such as acrylates. However, in the context of the present invention use is preferably made of a binder that itself comprises one or more ethylenically unsaturated functional groups, for instance a binder of the abovementioned types comprising one or more ethylenically unsaturated functional groups.

Particularly preferably, an ethylenically unsaturated binder of the polyalkenamer type may be used in the context of the present invention. The at least one binder used may therefore comprise or consist of at least one polyalkenamer. The term “polyalkenamer” herein means polymers comprising a base structure

—[(CH₂)ₓ—CH═CH]ₙ—
with x as an integer (typically in the range of 3 to 13) and n>2, usually n>10, frequently n>50. These polymers may be present in open-chain form, in cyclic form or as a mixture of open-chain and cyclic molecules. Either one or more hydrogen atoms of the base structure may be substituted by one or more organic groups, for example alkyl groups, or the base structure is not substituted. A polyalkenamer can introduce C═C double bonds, that can be crosslinked, into the mixture and also generally has good chemical compatibility with customary elastomer components. According to the invention, the binder may in particular comprise or consist of a poly-C₅-C₁₅-alkenamer. Examples of poly-C₅-C₁₅-alkenamers that may be used in the context of the present invention include, for instance, polypentenamer, polyhexenamer, polyheptenamer, polyoctenamer, poly(3-methyloctenamer), polydecenamer, poly(3-methyldecenamer), polydodecenamer, or mixtures and combinations thereof. Poly-C₅-C₁₅-alkenamers are obtainable by ring-opening metathesis polymerization of a corresponding cycloolefin, such as cyclopentene, cyclohexene, cycloheptene, cyclooctene, cyclodecene, cyclododecene or substituted derivatives thereof. The ring-opening metathesis polymerization reaction is catalyzed by Ziegler-Natta catalysts such as halides or acetylacetonates of W, Mo or Rh with AlEt₃ or AlEtCh₂ and an activator.

Polyalkenamers that may be used according to the invention as binder typically have a weight-average molecular weight (Mw) of 10 000 g/mol or more, for instance 20 000 g/mol or more, for instance 50 000 g/mol or more, for instance 80 000 g/mol or more, for instance 100 000 g/mol or more. For example, the polyalkenamer may have a weight-average molecular weight (Mw) of 300 000 g/mol or less, for instance 250 000 g/mol or less, for instance 200 000 g/mol or less, or 180 000 g/mol or less, or 150 000 g/mol or less. The weight-average molecular weight (Mw) of the polyalkenamer may be in a range formed by any desired combination of abovementioned values, for example of 10 000 g/mol to 250 000 g/mol, preferably in the range of 80 000 to 180 000 g/mol. The weight-average molecular weight (Mw) of the polyalkenamer may be determined by way of gel permeation chromatography (GPC) using polystyrene standards. The weight-average molecular weight of the polyalkenamer may be determined here by GPC by means of DIN 55672-1.

The polyalkenamer may be characterized by its thermal properties and in particular have a relatively low melting or softening temperature, as described above. As an alternative or in addition, the polyalkenamer may be characterized by its crystalline fraction. For example, the polyalkenamer may thus have a crystalline fraction of 20% or more, for instance 25% or more, or 30% or more under standard conditions (20° C., 101.3 kPa). The polyalkenamer may for example have a crystalline fraction of 60% or less, for instance 50% or less, for instance 40% or less, for instance 35% or less. The crystalline fraction may be in a range formed by any desired combination of abovementioned values, for example in the range of 20% to 50%, or of 25% to 35%. The crystalline fraction of the polyalkenamer may be determined by means of differential scanning calorimetry in accordance with DIN EN ISO 11357-7. It is also possible to determine the crystalline fraction of a polyalkenamer by means of X-ray diffraction methods, such as described in Wenig, W., H.-W. Fiedel, and J. Petermann. “The Microstructure of Trans-Polyoctenamer”. Colloid & Polymer Science 266, No. 3 (March 1988): 227-34.

According to the invention, one polyalkenamer or a mixture or combination of two or more polyalkenamers may be used as binder. Preferably, the binder used according to the invention comprises or consists of a polyoctenamer. In particular, the polyoctenamer may be a 1,8-polyoctenamer. The polyoctenamer may have a trans/cis double bond ratio of at least 60:40, preferably 70:30 or more, for instance in the range of 75:25 to 90:10. The trans/cis double bond ratio may be determined by means of infrared spectroscopy (FT-IR), such as described in Schneider, Wolfgang A, and Michael F Muller. “Crystallinity and thermal behaviour of trans-poly(l-octenylene)”. Macromolecular Chemistry and Physics 189, No. 12 (1988): 2823-2837. Polyoctenamers having predominately trans double bonds are also referred to as trans-polyoctenamers. Polyoctenamers are commercially available under the Vestenamer® trade name from Evonik.

The one or more additives comprising the binder and the ethylenically unsaturated functional groups, for instance the abovementioned polyalkenamer, are usually used in a total amount of 1 part by weight or more, based on 100 parts by weight of the elastomer-containing powder or pelletized material. For example, the one or more additives comprising the binder and the ethylenically unsaturated functional groups may be used in a total amount of preferably 2 parts by weight or more, 3 parts by weight or more, or 4 parts by weight or more, or 5 parts by weight or more, or 8 parts by weight or more, or 10 parts by weight or more, based on 100 parts by weight of the elastomer-containing powder or pelletized material. For example, the one or more additives comprising the binder and the ethylenically unsaturated functional groups may be used in a total amount of 30 parts by weight or less, preferably of 20 parts by weight or less, more preferably of 18 parts by weight or less, even more preferably of 15 parts by weight or less, based on 100 parts by weight of the elastomer-containing powder or pelletized material. As mentioned above, the polyalkenamer may form the binder. The at least one polyalkenamer may therefore be used in an amount that may be in the range of the above-specified amounts. The at least one polyalkenamer may thus be used in a total amount of 1 part by weight or more, based on 100 parts by weight of the elastomer-containing powder or pelletized material, for example in a total amount of preferably 2 parts by weight or more, 3 parts by weight or more, or 4 parts by weight or more, or 5 parts by weight or more, or 8 parts by weight or more, or 10 parts by weight or more, based on 100 parts by weight of the elastomer-containing powder or pelletized material. For example, the at least one polyalkenamer may be used in a total amount of 30 parts by weight or less, preferably of 20 parts by weight or less, more preferably of 18 parts by weight or less, even more preferably of 15 parts by weight or less, based on 100 parts by weight of the elastomer-containing powder or pelletized material. The total amount of abovementioned additives, for instance of polyalkenamer, may be in a range formed by any desired combination of abovementioned values, for example in a range of 1 to 30 parts by weight, preferably of 2 to 20 parts by weight, based on 100 parts by weight of the elastomer-containing powder or pelletized material.

As desired, in addition to the elastomer-containing powder or pelletized material and the above-described one or more additives comprising the binder and the ethylenically unsaturated functional groups, the mixture used to produce compacts composed of a crosslinkable material according to the present invention may comprise one or more further components.

At least one polymer different from the elastomer-containing powder or pelletized material and the above-described additives comprising the binder and the ethylenically unsaturated functional groups may thus also be used, as desired, in the mixture used to produce compacts composed of a crosslinkable material according to the present invention. The optional additional polymer may for example be a thermoplastic polymer, for instance a polyolefin, a polyester such as polyethylene terephthalate, a polyamide, polystyrene, polyvinyl chloride or a mixture or combination thereof. Examples of suitable polyolefins include, for instance, polyethylene, polypropylene and ethylene- and/or propylene-based copolymers, optionally with one or more other comonomer(s). The optional additional polymer is typically not an elastomer and/or is ethylenically saturated. Preferably, the optional additional polymer comprises or is a recycled polymer. Recycled polymers such as polyolefins are available on the market in large quantities at low cost. According to the invention, the use of the additional, preferably recycled polymer may serve for the production of compacts comprising polymer mixtures or blends, the properties of which can be set in wide ranges by selecting the relative amounts of the various polymers used. It is for instance possible for between 5% and 95% by weight, such as between 20% and 80% by weight, of the abovementioned amount of elastomer-containing powder or pelletized material in the mixture to be replaced by the optional additional polymer.

The material mixture from which the compacts according to the invention are produced comprises crosslinkable groups, in particular ethylenically unsaturated groups. By way of example, these may be crosslinked in a step downstream of the production of the compacts, as described in more detail further below in connection with the further processing of the compacts, by exposure to actinic radiation, heating and/or under the action of any residues of crosslinking-active substances contained in the elastomer-containing powder or pelletized material. To promote this downstream crosslinking, one or more crosslinking agents may be added in a controlled manner to the mixture used to produce the compacts. Useful crosslinking agents here are all substances by way of which the material mixture can be crosslinked to form a three-dimensional network. This crosslinking may in particular be effected by way of chemical reaction with involvement of the ethylenically unsaturated functional groups, as a result of which covalent bonds can be formed between originally separate polymer molecules or particles, and a three-dimensional network can thus be formed. Crosslinking agents used may therefore be any crosslinking agents known from the prior art that are suitable for the crosslinking of ethylenically unsaturated polymers. Known customary crosslinking systems, such as those described, for instance, in F. Röthemeyer, F Sommer, Kautschuk Technologie, 3^{rd} ed., Hanser Verlag, 2013, are based, for instance, on sulfur or sulfur-containing compounds, or on peroxides, and may be used in the context of the present invention. Therefore, the at least one crosslinking agent may for example comprise one or more peroxides. Peroxidic crosslinking agents used here may in particular be organic peroxides. Examples of suitable organic peroxides include, for instance, dicumyl peroxide, di (2,4-dichlorobenzoyl) peroxide, tert-butyl peroxybenzoate, 1,1-di (tert-butylperoxy)-3,3,5-trimethylcyclohexane, butyl 4,4-di (tert-butylperoxy) valerate, di (2-tert-butylperoxyisopropyl)benzene, tert-butyl cumyl peroxide, 2,5-dimethyl-2,5-di (tert-butylperoxy) hexane, di-tert-butyl peroxide, 2,5-dimethyl-2,5-di (tert-butylperoxy) hex-3-yne, or mixtures and combinations thereof. Such peroxidic crosslinking agents are commercially available, for instance, under the Peroxan® trade name from Pergan. As an alternative or in addition, the at least one crosslinking agent may comprise sulfur and/or sulfur donors. Elemental sulfur may thus preferably be used as crosslinking agent in the composition according to the invention. Elemental sulfur may be used in soluble form or insoluble form, preferably in soluble form. Soluble sulfur here means the form of yellow sulfur which is stable at normal temperatures (cyclooctasulfur, Sa, also referred to as a-sulfur), which is highly soluble in CS₂. In contrast, insoluble sulfur is understood to mean sulfur modifications which are sparingly soluble in CS₂. In addition or as an alternative to the sulfur, it is possible to use one or more sulfur donors as crosslinking agent. Examples of sulfur donors are, for instance, dithioalkanes, dicaprolactam sulfides, polymeric polysulfides, sulfur-olefin adducts, or thiurams such as tetramethylthiuram disulfide, tetraethylthiuram disulfide or dipentamethylenthiuram tetrasulfide. According to the invention, sulfur may preferably be used as crosslinking agent.

The crosslinking agent, if used, is generally used in an amount that is effective with regard to the crosslinking reaction. The crosslinking agent is usually used in an amount of 0.01 parts by weight or more, for instance 0.05 parts by weight or more, or 0.1 parts by weight or more, or 0.2 parts by weight or more, or 0.3 parts by weight or more, per part by weight of the above-described additive having ethylenically unsaturated functional groups. For example, the crosslinking agent may be used in an amount of 3 parts by weight or less, for instance 2 parts by weight or less, or 1 part by weight or less, or 0.8 parts by weight or less, or 0.5 parts by weight or less, per part by weight of the above-described additive having ethylenically unsaturated functional groups. For example, the crosslinking agent may be used in an amount that is in a range formed by any desired combination of abovementioned values, for instance of 0.01 to 2 parts by weight, or of 0.03 to 1 parts by weight, or of 0.1 to 0.5 parts by weight, per part by weight of the above-described additive having ethylenically unsaturated functional groups.

As desired, one or more crosslinking aids may also be used in the mixture. The one or more crosslinking aids may for example comprise one or more components selected from accelerators, activators, dispersants, complexing agents and retardants. Such crosslinking aids are described, for example, in F. Rothemeyer, F. Sommer, Kautschuk Technologie, 3rd ed., Hanser Verlag, 2013

Examples of accelerators include, for instance, xanthogenates, guanidines, dicarbamates, dithiocarbamates, thiurams, thiourea compounds, benzothiazole sulfonamides, aldehyde amines, amine derivatives such as tetramines, disulfides, thiazoles, sulfenamides, sulfenimides, piperazines, and amine carbamates. Exemplary specific compounds that may be used according to the invention as accelerator are, for instance, N-tert-butyl-2-benzothiazylsulfenamide, o-tolyl biguanidine (OTBG), 1,3-di-o-tolylguanidine (DOTG), N-cyclohexylbenzothiazole-2-sulfenamide (CBS), benzothiazyl-2-tert-butylsulfenamide (TBBS), benzothiazyl-2-dicyclohexylsulfenamide (DCBS), 1,3-diethylthiourea (DETU), 2-mercaptobenzothiazole (MBT), benzothiazyldicyclohexylsulfenamide (DCBS), 2-mercaptobenzothiazole disulfide (MBTS), dimethyldiphenylthiuram disulfide (MPTD), ethylenethiourea (ETU), triethyltrimethyltriamine (TTT); N-t-butyl-2-benzothiazolesulfenimide (TBSI), 1,1′-dithiobis (4-methylpiperazine), hexamethylenediamine carbamate (HMDAC), tetrabenzylthiuram disulfide (TBZTD), diethylthiourea (DETU), N,N-ethylenethiourea (ETU), diphenylthiourea (DPTU), benzothiazyl-2-tert-butylsulfenamide (TOBS), N,N′-diethylthiocarbamyl-N′-cyclohexylsulfenamide (DETCS), cyclohexylethylamine, dibutylamine, polyethylenepolyamines or polyethylenepolyimines such as triethylenetetramine (TETA).

The accelerator or accelerators is/are usually used in an amount that corresponds to a weight ratio of accelerator to crosslinking agent in the range of 1:5 to 5:1, for instance in the range of 1:4 to 4:1, or of 1:3 to 3:1 or of 1:2 to 2:1.

The activator used may for example be zinc oxide. Furthermore, a fatty acid or salt thereof, for example stearic acid or a stearate such as zinc stearate, may be used in the mixture. Such compounds may act as dispersants and complexing agents, for example. Preferably, in the mixture for producing the compacts according to the invention, use may for example be made of a crosslinking system comprising sulfur, one or more accelerators, zinc oxide and a fatty acid or a salt thereof, such as stearic acid.

Activators such as zinc oxide are usually used in an amount that corresponds to a weight ratio of activator to crosslinking agent in the range of 1:4 to 8:1, for instance in the range of 1:3 to 5:1, or of 1:2 to 4:1 or of 1:1 to 3:1.

Fatty acids or salts thereof, such as stearic acid or stearate, are usually used in an amount that corresponds to a weight ratio of fatty acid/salt to crosslinking agent in the range of 1:10 to 10:1, for instance in the range of 1:8 to 8:1.

As desired, the mixture used to produce compacts composed of a crosslinkable material according to the present invention may additionally also comprise, according to the requirement and use, one or more further components, such as those commonly used in the field of elastomer compositions, for instance fillers, pigments, dyes, plasticizers, processing aids, for instance oils, mould release agents, flame retardants, ageing stabilizers, UV stabilizers or ozone stabilizers, and adhesives. If used, such optional components are used in amounts suitable for achieving the respective purpose. Advantageous amounts can be determined by those skilled in the art using experiments customary in the art.

The mixture used for the production according to the invention of the compacts can be produced in a cost-effective and efficient manner using customary techniques and equipment from the field of powder processing. It is thus possible to mix the elastomer-containing powder or pelletized material, the one or more additives comprising the binder and the ethylenically unsaturated groups, and any further optional components, in suitable amounts, as are described above, in a mixer with homogenization to form a corresponding mixture. For example, the mixer used may be a normal powder mixer or preferably a high-speed mixer such as a Henschel blender, Speed Mixer or fluid mixer. The mixing may for example follow the procedure described in EP 0 508 056 B1 or in Diedrich, K M, and B J Burns “Possibilities of ground tire recycling with trans-polyoctenamer”. Gummi, Fasern, Kunststoffe 53, No. 3 (2000): 178-183. The production of the mixture using powder mixing technology is generally more cost-effective than the production of comparable mixtures based on raw rubber. For example, in terms of capital costs and operating costs, powder mixers are generally significantly cheaper than the roller mixers or internal mixers usually used for the processing of raw rubber-based compositions.

Moreover, it is also possible to use the compacts composed of the crosslinkable material that are produced according to the invention again to provide an above-described starting mixture. One or more compacts comprising at least the elastomer-containing powder or pelletized material, and the one or more additives comprising the binder and the ethylenically unsaturated groups, and any further optional components, may thus be comminuted, for instance using a mill or another mechanical comminution apparatus, and be used to produce the mixture, as described above. In this way, for example, compacts that arise as waste, such as those that are sorted out in a quality control step, may be effectively recycled in the method according to the invention.

The components contained in the mixture provided, such as the elastomer-containing powder or pelletized material, the one or more additives comprising the binder and the ethylenically unsaturated groups, and any further optional components such as a crosslinking agent, are generally physically mixed with one another, for instance in the form of a blend, but are not joined by fixed chemical bonds, such as covalent bonds. The content of crosslinkable functional groups, particularly ethylenically unsaturated functional groups, makes the material mixture crosslinkable. The mixture obtained is usually flowable or free-flowing.

The mixture provided typically has a bulk density of less than 1.0 g/cm³, for example of 0.9 g/cm³ or less, of 0.8 g/cm³ or less, or of 0.7 g/cm³ or less, or of 0.6 g/cm³ or less. For example, the mixture may have a bulk density of 0.1 g/cm³ or more, or of 0.2 g/cm³ or more, or of 0.3 g/cm³ or more, or of 0.4 g/cm³ or more. For instance, the mixture may have a bulk density that is in a range formed by any desired combination of abovementioned values, for example of 0.1 g/cm³ to 1.0 g/cm³, or of 0.2 g/cm³ to 0.8 g/cm³, or of 0.3 g/cm³ to 0 7 g/cm³. The bulk density may for example be determined in accordance with DIN ISO 697.

From the crosslinkable material mixtures described above, it is possible according to the invention to produce compacts that consist of a corresponding crosslinkable material and may have a significantly higher density than the bulk density of the starting mixture.

To this end, the provided, electively heated mixture is compacted using a shaping tool to form a compact. The compaction using a shaping tool to form a compact may be performed with application of pressure or reduced pressure (vacuum). The compaction is generally performed after the mixture has been provided, using a shaping tool provided for this purpose and under controlled conditions. By way of the compaction, a shaped body having a defined shape that is determined by the shaping tool is generally formed as compact. A compaction of the mixture that may occur during mixing, for instance in a mixer, should accordingly be distinguished from this and usually does not lead to the formation of a compact.

There are no restrictions on the type, shape and dimensions of the shaping tool used in the method according to the invention for producing the compacts. Any shaping tools known per se from the prior art that are suitable for producing compacts may be used according to the invention. The shaping and/or compaction may for example be performed batchwise or continuously, for instance by means of compression moulding or extrusion. The compaction may for example be performed in a press mould with application of pressure.

The mixture used is generally compacted by a compression factor of >1 in this case. The compression factor indicates the ratio of the geometric density (D_{g}) of the material used in the pressurized shaping tool to the bulk density (Dₛ) of the starting mixture. If a defined amount of a starting mixture with a bulk density (Dₛ) and a starting volume (Vₛ) is compacted to a specific volume (V_{g}) in a press mould, then the geometric density (D_{g}) of the material used in the pressurized shaping tool can be calculated therefrom and the corresponding compression factor can be specified. For example, in the method according to the invention, the mixture used may be compacted by a compression factor of at least 12, or of at least 1.3, or of at least 1.4, or of at least 1.5, or of at least 16, or of at least 1.7, or of at least 1.8, or of at least 2.0. For example, the mixture used may be compacted by a compression factor of 4.0 or less, or of 3.5 or less, or of 3.0 or less, or of 2.5 or less. The mixture may be compacted according to a compression factor that is in a range formed by any desired combination of abovementioned values, for example in the range of 1.2 to 3.5 or of 1.8 to 4.0 or of 2.0 to 3.0. Preferably, in the method according to the invention the material mixture used is compacted by a compression factor of at least 1.4, particularly preferably of at least 1.8 or of at least 2.0. This makes it possible to achieve particularly advantageous properties of the compact in terms of good material cohesion and high strength and density.

According to the invention, the compaction may in particular be performed with application of pressure. The pressure exerted in the method according to the invention for the compaction may vary depending on the shaping tool used, the material and the desired degree of compaction. In general, the pressure may be selected in such a way that a compaction by a compression factor, as described above, is performed. For example, the pressure exerted may be in a range of 0.1 MPa to 20 MPa, for example in a range of 0.3 MPa to 10 MPa or of 0.5 MPa to 5 MPa. As described above, the compaction may also be performed by application of reduced pressure (vacuum), for example at 0.05 MPa to 0.1 MPa.

The compaction is typically carried out for a duration that is long enough to achieve the desired compaction and consolidation of the material mixture, and on the other hand is as short as possible in order to take account of economic factors. The compaction duration may therefore vary within wide limits, from a few seconds to several hours. For example, the compaction duration may thus be at least 10 seconds, for instance at least 20 seconds, for instance at least 30 seconds, or at least 1 minute, or at least 5 minutes. The material mixture may be compacted for instance for a duration of 120 minutes or less, such as 90 minutes or less, 60 minutes or less, or 40 minutes or less, or 30 minutes or less, or 20 minutes or less, or 10 minutes or less.

The mixture may be compacted for a duration that is in a range formed by any desired combination of abovementioned values, for example in the range of 10 seconds to 120 minutes or of 20 seconds to 90 minutes, or of 30 seconds to 30 minutes.

As already mentioned above, the mixture that is compacted to form a compact is heated The mixture may be heated before and/or during the compaction. For instance, the mixture may be heated before it is introduced into the shaping tool, for example in the course of the above-described production of the mixture. For example, the mixture may be heated in the mixing operation for instance by the resulting frictional heat and/or by external supply of heat, for instance by way of a heating device of the mixer used. In addition or as an alternative to this, the mixture may be heated after the mixing operation, for instance in a temperature-controlled storage container or in a furnace. In addition or as an alternative, the mixture may be heated after it is introduced into the shaping tool, for example by means of a heatable press mould. Furthermore, heating by way of irradiation, for instance by means of microwave radiation or infrared radiation, Is also possible, for example.

Advantageous properties of the compact in terms of good material cohesion and high strength and density can be achieved by heating the material mixture.

The mixture used that is compacted to form a compact is preferably heated in the method according to the invention to a temperature approximately in the range of the melting or softening temperature (Tₘ) of the binder or polyalkenamer or above it. The mixture may thus be heated to a temperature greater than or equal to (Tₘ−10 K), for instance to a temperature greater than or equal to (Tₘ−5 K), or to a temperature greater than or equal to Tₘ, or to a temperature greater than or equal to (Tₘ+5 K), or to a temperature greater than or equal to (Tₘ+10 K). For example, the mixture may be heated to a temperature less than or equal to (Tₘ+50 K), for instance to a temperature less than or equal to (Tₘ+40 K), to a temperature less than or equal to (Tₘ+30 K), or to a temperature less than or equal to (Tₘ+20 K). The material mixture may be heated to a temperature that is in a range formed by any desired combination of abovementioned values, for example in the range of (Tₘ−10 K) to (Tₘ+50 K), or in the range of Tₘ to (Tₘ+40 K). However, the mixture is not heated to temperatures of 120° C. or more. The mixture that is compacted to form a compact is therefore generally heated to a temperature of <120° C. A temperature of the mixture of less than 120° C. makes it possible to avoid crosslinking reactions taking place during the production of the compact to a significant extent, and to thus maintain the formability and crosslinkabilty of the material. For example, the mixture that is compacted to form a compact may be heated to a temperature in the range of Tₘ to <120° C. or of 40° C. to 120° C. The mixture may be heated for instance to a temperature of 45° C. or more, 50° C. or more, 55° C. or more, 60° C. or more, 65° C. or more, or 70° C. or more. The mixture that is compacted to form a compact may be heated for instance to a temperature of 115° C. or less, for instance 110° C. or less, 105° C. or less, 100° C. or less, 95° C. or less, or 90° C. or less. The mixture that is compacted to form a compact may be heated to a temperature in a range that results from a combination of abovementioned values, for instance in the range of Tₘ to 110° C., or of 60° C. to 110° C., or of (Tₘ+10 K) to 100° C., or of 70° C. to 100° C.

In particular, the compaction in the method according to the invention may be performed under conditions under which the binder is formable and/or flowable. For example, a binder that is in solid form under standard conditions can thus be converted into a soft and/or flowable state by applying pressure and heating to a temperature higher than ambient temperature, for example as described above in the range of the melting or softening temperature (Tₘ) of the binder or above it, and can thus during the compression effectively fill hollow spaces, penetrate between particles of the elastomer-containing powder or pelletized material and wet them, swell them, bind them to one another and/or activate them for crosslinking.

After the material has been compacted, the compact formed is demoulded. The compact may then be removed from the shaping tool. The demoulding is generally performed after reducing the pressure applied for the compression, in particular to ambient pressure, for example after opening the press mould or passing through the extruder outlet. The demoulding includes releasing the compact formed from the shaping tool. This may for example be performed manually or by machine. For example, the demoulding may include releasing by striking, knocking, gripping. application of elevated or reduced pressure, punching, cutting or a combination thereof. As desired, a mould release agent may also be used.

The mixture that has been heated for the compacting to form the compact is cooled before the demoulding. The mixture is cooled to a temperature below the melting or softening temperature (Tₘ) of the binder. This makes it possible for the softened/flowable binder or polyalkenamer to return to a more rigid and/or solid state, and thus to contribute to the strength and good material cohesion of the compact formed. The compact may thus be demoulded for instance at a temperature of less than or equal to (Tₘ−5 K), or a temperature of less than or equal to (Tₘ−10 K), or a temperature of less than or equal to (Tₘ−20 K). For example, the compact may be demoulded at a temperature of 10° C. or more, for instance 15° C. or more, or 20° C. or more, or 25° C. or more. The compact may be demoulded at a temperature that is in a range formed by any desired combination of abovementioned values, for example in the range of ambient temperature (for instance 10-25° C.) up to <Tₘ, for instance of 10° C. to <Tₘ, or of 15° C. to (Tₘ−5 K). The demoulding is usually performed at a temperature of less than 60° C., for instance of less than 40° C., for example in the range of 10° C. to 40° C., for instance approximately at ambient temperature

The compacts obtainable by the method according to the invention consist of a crosslinkable material that is defined by the material mixture used to produce the compact. For instance, the compacts obtained may still comprise at least 70%, preferably at least 90% or essentially all, of the crosslinkable ethylenically unsaturated functional groups contained in the originally provided material mixture used to produce the respective compact. Said compacts can be processed further as such, as described in more detail below, to form crosslinked elastomer compounds and shaped bodies formed therefrom. These compacts may have a ready-to-use composition that can be further processed effectively, without the need to add further components, to form crosslinked elastomer compounds and shaped bodies formed therefrom.

The compacts produced according to the invention may have a significantly higher density than the bulk density of the starting mixture. For example, the compacts may have a geometric density that is greater than the bulk density of the material mixture used to produce the respective compact by a factor of 1.2 or more, or of 1.3 or more, or of 1.4 or more, or of 1.5 or more, or of 1.6 or more, or of 1.7 or more, or of 1.8 or more, or of 2.0 or more, or of 2.5 or more. The compacts may for example have a geometric density that is greater than the bulk density of the material mixture used to produce the respective compact by a factor of up to 5.0, for instance of up to 4.0, or of up to 3.5, or of up to 3.0. The compacts may have a geometric density that is greater than the bulk density of the material mixture used to produce the respective compact by a factor that is in a range formed by any desired combination of abovementioned values, for example by a factor in the range of 1.2 to 5.0, for instance in the range of 1.5 to 4.0, or of 1.8 to 3.0. Said compacts therefore make it possible to convert elastomer-containing powders or pelletized materials, for instance based on recycled elastomers, for example obtained from used tyres, into a form that is easy to handle, can be processed further and has a significantly higher density. The compacts may have a density that is close to the theoretical density of the corresponding crosslinked material. For example, the compacts produced according to the invention may have a geometric density that corresponds to 20% or more, preferably 50% or more, more preferably 70% or more, even more preferably 80% or more, or 90% or more, of the theoretical density of the corresponding crosslinked material. The compacts according to the invention can therefore be stored, transported and processed further in a space-saving and cost-saving manner. On account of the relatively high density, further processing of the compacts using customary shaping tools, such as those used to process raw rubber-based feed materials, is generally possible, without the need for specially made tools with a larger filling volume, as is regularly the case when elastomer-containing powders or pelletized materials are processed directly to form crosslinked elastomer compounds and shaped bodies formed therefrom. The compacts produced according to the invention are also easier and cleaner to handle than powders or pelletized materials, and can be handled by way of common means such as grippers or conveyor belts that are used for handling rubber blanks. The production of the compacts based on powder mixing technology is much more cost-effective than the production of comparable mixtures based on raw rubber. The compacts according to the invention are therefore of very good suitability for the substitution of raw rubber or raw rubber-containing compositions in existing production processes. The strength and the material cohesion of the compacts may be adjusted here through the selection of the process conditions, as illustrated in the examples. According to the invention, it is possible to produce consolidated compacts of high strength and having good material cohesion.

Compacts obtained may also, as mentioned above, be recycled in the method according to the invention and reused in the step of providing a mixture to produce compacts. As a result, for example, compacts that arise as waste, such as those that are sorted out in a quality control step, may be recycled in the method according to the invention, this increasing the economic viability of the method.

Compacts composed of a crosslinkable material that have a wide variety of shapes and dimensions may be produced by the method according to the invention. The shape and dimensions may be determined here through the selection of the shaping tool used to produce the compact. Possible shapes range from simple shapes such as cuboids, cubes, blocks, plates, panels, strands, pellets, spheres or cylinders, to complex geometric shapes. The compacts usually have a length in the direction of maximum extent (maximum length) of less than or equal to 200 cm, for instance of less than or equal to 100 cm, or of less than or equal to 50 cm, or of less than or equal to 30 cm, or of less than or equal to 10 cm. For example, the compacts may have a length in the direction of maximum extent (maximum length) of 1 cm or more, for instance of 2 cm or more, or of 5 cm or more, or of 10 cm or more. For instance, the compacts may have a maximum length that is in a range formed by any desired combination of abovementioned values, for example in the range of 1 cm to 200 cm, or of 2 cm to 30 cm. For instance, the compacts according to the invention may have a volume of less than or equal to 1000 cm³, for instance of less than or equal to 500 cm³, of less than or equal to 200 cm³, of less than or equal to 100 cm³, of less than or equal to 50 cm³, or of less than or equal to 20 cm², or of less than or equal to 10 cm³. For example, the compacts according to the invention may have a volume of 1 cm³ or more, for instance of 2 cm³ or more, or 5 cm³ or more, or of 10 cm³ or more, or of 20 cm³ or more, or of 50 cm³ or more. For instance, the compacts may have a volume that is in a range formed by any desired combination of abovementioned values, for example in the range of 1 cm³ to 1000 cm³, for instance in the range of cm³ to 200 cm³. However, compacts having larger dimensions are also possible according to the invention, for instance having volumes of 10 000 cm³ or more, or 0.1 m³ or more or of 1 m³ or more, and/or maximum lengths of more than 2 m, for instance of up to 3 m or more, or 5 m or more, or 10 m or more. For example, it is possible to produce compacts of any desired length for instance by means of extrusion. Said compacts can be taken up for example in the form of a roll, coil, spindle or a layer structure (for instance wigwag sheet). If required, the taken-up, for example rolled-up, compact can be removed, for example unrolled, again, and divided.

Provision may be made for the compact to be preportioned. For instance, it is possible to form compacts having specifically predefined portions (for example specific masses), in order to facilitate packaging and metering. For example, a compact according to the invention may have one or more predetermined breaking points. The predetermined breaking points may enable straightforward splitting of the compact into several parts with the same or different sizes. The predetermined breaking points may for example be formed in the form of narrowings, webs, perforations or other connecting elements that can be mechanically separated comparatively easily.

Elastomer compounds and shaped bodies formed therefrom can be produced from the above-described compacts composed of a crosslinkable material according to the invention. “Elastomer compound” is understood herein to mean a dimensionally stable elastomer-containing material having rubber-elastic properties. Elastomer compounds may be produced by crosslinking (also referred to as vulcanization) of the crosslinkable material described herein. The crosslinking may for example be performed by irradiation with actinic radiation and/or heating to a temperature at which a chemical crosslinking reaction takes place in the composition. By way of the chemical crosslinking reactions, links can be formed via covalent bonds between originally separate molecules, and a three-dimensional network can thus be formed. In the present case, the crosslinking may in particular be effected by chemical reaction with involvement of ethylenically unsaturated functional groups that may be present both in the additive component, for instance in the binder, in particular the polyalkenamer, and in the (activated) elastomer-containing powder or pelletized material, for example under the action of a crosslinking agent, for instance with formation of sulfur bridges. It is thus possible to form a wide-mesh three-dimensional network which imparts rubber-elastic properties to the resulting crosslinked material. Therefore, in the elastomer compound obtainable from the crosslinkable material, the additive component and the elastomer-containing powder or pelletized material may be present crosslinked with one another. The particles of the powder or pelletized material are therefore generally incorporated firmly in the elastomer compound.

It is possible to produce shaped bodies composed of a crosslinked elastomer compound directly from the compacts according to the invention themselves, without the need for further shaping. For this purpose, a compact composed of a crosslinkable material, as described above, is provided, and then the crosslinkable material is crosslinked to form a crosslinked elastomer compound. This procedure may in particular be used if the compacts already have the desired final shape.

However, the compacts may especially also be used in a shaping production of elastomer-based shaped bodies. In this case, a feed material for a shaping tool, comprising at least one compact composed of a crosslinkable material according to the invention or one or more parts thereof, may be provided. For this purpose, if required, the at least one compact may be comminuted or broken up. In addition to the compact according to the invention, the feed material may optionally comprise further components, for example binders and/or processing aids such as mould release agents, and/or reinforcing fabrics or fibres. The feed material is then shaped using the shaping tool to form a desired shape and the feed material is crosslinked to form a crosslinked elastomer compound. The shaping by means of the shaping tool may be performed before, during and/or after the crosslinking, preferably before and/or during the crosslinking. Customary process techniques and tools, such as those known to those skilled in the art from the field of the processing of rubber compositions and described, for instance, in F. Röthemeyer, F. Sommer, Kautschuk Technologie, 3^{rd} ed., Hanser Verlag, 2013, may be used for the crosslinking and shaping of the compositions according to the invention. As described above, the compacts according to the invention in particular advantageously allow the use of shaping tools, such as those otherwise used for the processing of raw rubber-based feed materials. For example, the shaping may be performed by way of compression moulding, extruding or transfer moulding.

Regardless of whether or not shaping is performed, the crosslinking may in particular be performed at a temperature of greater than 120° C., for instance 140° C. or more, for instance 150° C. or more, for instance 160° C. or more. For example, the crosslinking may be carried out at a temperature of 250° C. or less, for instance 220° C. or less, for instance 200° C. or less, for instance 180° C. or less. For example, the crosslinkable material may be crosslinked at a temperature that is in a range formed by any desired combination of abovementioned values, for example of 120° C. to 250° C., or of 140° C. to 220° C. The crosslinking is preferably carried out at a temperature in the range of 140° C. to 200° C.

The crosslinking time is guided by the crosslinking temperature used and the dimensions of the amount used of material to be crosslinked. The crosslinking is generally carried out in a time of 60 minutes or less, for example in a time of 30 minutes or less, or 20 minutes or less, or 15 minutes or less, or 10 minutes or less, or 5 minutes or less. For example, the crosslinking may be performed in a time of 10 seconds or more, for instance 15 seconds or more, for instance 30 seconds or more, for instance 1 minute or more, for instance 2 minutes or more, for instance 5 minutes or more. The crosslinking of the crosslinkable material may be carried out for a time that is in a range formed by any desired combination of abovementioned values, for example for a time in the range of 10 seconds to 60 minutes, for instance in the range of 2 to 30 minutes The crosslinking time is usually in the range of 1 to 20 minutes. Low crosslinking temperatures and large dimensions of material to be crosslinked tend to require longer crosslinking times.

Shaped bodies that have a wide variety of shapes and dimensions may thus be produced from the compacts according to the invention. The shaped bodies produced may themselves represent usable products or be used after further processing and/or as parts in products. The compacts according to the invention may thus be used for the production of any customary products from the rubber-processing industry, for example of tyres or tyre components, cable sheaths, tubes, mats, coverings, conveyor belts, drive belts, rollers, coatings, hoses, dampers, protective elements, shoe soles, balls, sealing elements, or profiles, and containers of any kind such as cups, pots and buckets.

The elastomer compounds obtainable from the compacts according to the invention and shaped bodies formed therefrom may have good material cohesion and good mechanical properties that are able to satisfy even relatively demanding applications.

The compacts according to the invention are, however, generally of excellent suitability for the substitution of raw rubber or raw rubber-containing compositions in existing production processes.

The present invention is illustrated hereinafter on the basis of some specific examples. The examples are exemplary and serve for illustration. The examples should not be regarded as a restriction to the invention; rather, the invention extends to the entire breadth, including equivalents, set forth in the general description and the claims which follow.

### EXAMPLES

### Production of Material Mixtures (Examples 1-6)

Various material mixtures based on elastomer-containing powder composed of used tyres (ground tyre rubber, GTR) were produced

For this purpose, the starting materials listed in Table 1, in the reported amounts, were mixed in a Hauschild SpeedMixer DAC 400 mixer (Hauschild GmbH & Co KG, Germany) at high mixing speed (1800 rpm) in each case to form a homogeneous material mixture. The material mixture was heated here to a temperature of 85° C.±5° C. by the mixing operation. The temperature was determined using an infrared thermometer (Bosch UniversalTemp).

The amounts of the individual components are reported in Table 1 as parts by weight based on 100 parts by weight of the powder composed of used tyres (parts per hundred rubber component, “phr” for short).

TABLE 1

| | Ex. 1* | Ex. 2* | Ex. 3 | Ex. 4 | Ex. 5 | Ex. 6 |
|---|---|---|---|---|---|---|
| Component | Amount [phr] | | | | | |
| GTR¹ | 100 | 100 | 100 | 100 | 100 | 100 |
| Binder² | — | — | 3 | 3 | 10 | 3 |
| Oil³ | — | 12 | — | 12 | 12 | 24 |
| Sulfur⁴ | — | — | — | 0.8 | 2.67 | 0.8 |
| Zinc oxide⁵ | — | — | — | 1.5 | 5 | 1.5 |
| Stearic acid⁶ | — | — | — | 0.5 | 1.67 | 0.5 |
| CBS⁷ | — | — | — | 0.8 | 2.67 | 0.8 |
| TBzTD⁸ | — | — | — | 0.2 | 0.67 | 0.2 |
| Bulk density Dₛ [g/cm³] | 0.43 | 0.36 | 0.42 | 0.38 | 0.43 | 0.36 |

*Comparative example
¹Powder composed of used tyres (ground tyre rubber, GTR), particle size <425 μm, commercially available from Genan GmbH
²Polyoctenamer, commercially available from Evonik under the Vestenamer ® trade name, Tₘ: 54° C.
³Vivatec 500, commercially available from Hansen & Rosenthal
⁴Ground sulfur, commercially available from Avokal
⁵Zinc oxide, ultrapure, commercially available from Dr. Wieland GmbH & Co. KG
⁶commercially available from Calcic
⁷N-Cyclohexylbenzothiazole-2-sulfenamide, vulcanization accelerator, commercially available from Lanxess
⁸Tetrabenzylthiuram disulfide, vulcanization accelerator, commercially available from Richon

The mixtures obtained in this way were pulverulent and free-flowing. The bulk density of the material mixtures was determined by weighing out 100 g of the respective material mixture, introducing the weighed-out amount of the material mixture into a cylindrical measuring cup (diameter: 10 cm) and reading off the volume occupied by the material mixture in the measuring cup. The bulk densities determined as the quotient of the respective volume determined to the weight used of the material mixture are reported in Table 1.

### Production of Compacts (Examples 1-6)

Compacts were produced from the produced material mixtures of Examples 1-6 by compression moulding (using an unheated mould). For this purpose, 100 g of the respective heated (T: 85° C.±5° C.) material mixture was placed in a cylindrical cavity (diameter 7 cm) of an unheated press mould made of ASA plastic (ASA Extrafill from Fillamentum) and then compacted with application of pressure by means of a compression die of a press (Lauffer RLKV 25/1) that engages into the cavity from above in a form-fitting manner. To this end, by means of the press, the compression die was brought into a position corresponding to a spacing (h) of 26 mm between the planar die surface of the compression die that comes into contact with the material mixture and the planar bottom surface of the cylindrical cavity. The pressure applied was approximately in the range of 0.5-3 MPa. After a compression duration of about 90 minutes, the press mould was opened by removing the compression die from the cavity and the cylindrical compact formed was then removed manually from the cavity. The temperature of the compact was measured here immediately before the demoulding by means of an infrared thermometer (Bosch UniversalTemp) and was in each case 30° C.±5° C.

The compacts obtained were examined and qualitatively assessed with regard to their strength and their material cohesion. For this purpose, the compacts obtained were dropped from a height of 2 metres onto a concrete floor. Furthermore, the material cohesion when manual pressure was applied was examined. The assessment was performed here according to a scale of 0-5, where:
0: no material cohesion (no consolidated compact formed)
1: low material cohesion (fragile compact, destroyed with little application of manual force or by falling)
2 moderate material cohesion (compact largely destroyed with application of manual force or by falling)
3 moderate to good material cohesion (compact largely withstands application of manual force, damaged by falling)
4: good material cohesion (compact withstands application of manual force, hardly damaged by falling)
5: very good material cohesion (compact withstands application of manual force, no/minimal damage by falling)

In addition, the density of the compacts obtained, as the geometric density (D_{g}) from the amount used of the compacted material mixture and the volume determined from the dimensions (diameter, height) of the respective cylindrical compact measured by means of a calliper, was determined

The determined properties of the compacts produced from the various material mixtures used are collated in Table 2 below. The ratio of the geometric density (D_{g}) of the respective compact obtained and the bulk density (Dₛ) of the material mixture used for the production thereof is likewise reported in Table 2.

TABLE 2

| | Ex. 1* | Ex. 2* | Ex. 3 | Ex. 4 | Ex. 5 | Ex. 6 |
|---|---|---|---|---|---|---|
| Material cohesion, | 0 | 2 | 3 | 5 | 5 | 2 |
| strength | | | | | | |
| Density D_{g} [g/cm³] | — | 0.65 | 0.72 | 0.84 | 0.95 | 0.71 |
| D_{g}/Dₛ | — | 1.8 | 1.7 | 2.2 | 2.2 | 2.0 |

*Comparative example

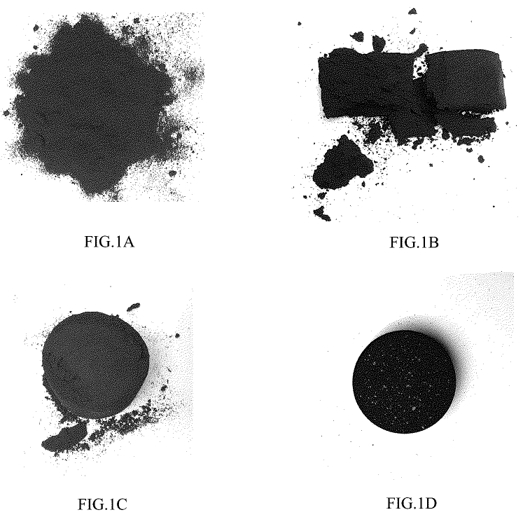

No consolidated compact is produced from the powder composed of used tyres alone (Example 1). As can be seen from FIG. 1a, the material used was still pulverulent even after the pressing operation. Although it is possible to produce compacts even from the powder composed of used tyres alone in the case of a significantly longer compression duration (>6 h), these compacts are of insufficient quality and have low material cohesion and low strength, with the result that they fall apart even in the case of little application of force. Adding a process oil to the powder composed of used tyres makes it possible to produce a consolidated compact, but the density and the material cohesion remain low (cf. Example 2), and the compact is, however, also of relatively low strength and is easily destroyed by falling (cf. FIG. 1b). In addition, the compacts produced in this way have hardly any crosslinking functionality and consequently cannot be effectively crosslinked to form consolidated elastomer compounds. In contrast, according to the invention, compacts are produced (cf. Examples 3-6) in which the elastomer-containing particles are effectively held together by a binder and have the additional crosslinking functionality, with the result that they can subsequently be effectively processed to form consolidated crosslinked elastomer compounds and shaped bodies formed therefrom. As can be seen from Table 2, even comparatively low relative amounts of the binder used result in proper material cohesion and a consolidated solid compact (cf. Example 3) that, as illustrated by FIG. 1c, largely withstands application of manual force and although is partially damaged by falling, fundamentally remains intact. Adding process oil, crosslinking agent and additives makes it possible to further increase the material cohesion, the strength and the density of the compact (cf Example 4). When larger amounts of binder are used, the strength and the density of the compact increase further (cf. Example 5). Consolidated compacts having great strength, excellent material cohesion and high density are obtained that, as shown by FIG. 1d in an exemplary manner for Example 4, withstand application of manual force and are hardly damaged, if at all, by falling. However, using particularly large amounts of process oil can reduce the strength and the material cohesion (cf. Example 6).

According to the invention, it is therefore possible to provide ready-to-use compacts that are easy to handle and can be effectively processed further by means of customary tools used for the shaping and crosslinking of raw rubber-based compositions.

### Variation of Process Parameters

a) Temperature of the material mixture (Examples 4 and 7-9)

Compacts were produced as described above by compression moulding (using an unheated mould) from the material mixture of Example 4, with the material mixture introduced into the cylindrical cavity of the press mould in each case having a different temperature T, namely a) 85° C.±5° C. (Example 4), b) 65° C.±5° C. (Example 7), c) 50° C.±5° C. (Example 8) or d) 30° C.±5° C. (Example 9). The different temperatures of the material mixture were set by varying the mixing duration, with shorter mixing durations resulting in lower temperatures on account of the shorter duration of action of heating frictional forces. In the case of Examples 4, 7 and 8, the compression duration was about 90 minutes, and in the case of Example 9 about 6 h.

The compacts obtained in this way were examined as described above with regard to their strength, their material cohesion and their density. The results are collated in Table 3.

TABLE 3

| | Ex. 4 | Ex. 7 | Ex. 8 | Ex. 9* |
|---|---|---|---|---|
| Temperature of the | 85 ± 5 | 65 ± 5 | 50 ± 5 | 30 ± 5 |
| material mixture [° C.] | | | | |
| Material cohesion, strength | 5 | 4 | 3 | 1 |
| Density D_{g} [g/cm³] | 0.84 | 0.77 | 0.72 | 0.65 |
| D_{g}/Dₛ | 2.2 | 2.0 | 1.9 | 1.7 |

*Comparative example

Even at temperatures below the melting temperature of the binder used (54° C.), compacts were consistently obtained which have crosslinking functionality and can subsequently be effectively processed to form consolidated crosslinked elastomer compounds and shaped bodies formed therefrom. However, the material cohesion, the strength and density of the compact were low without heating of the mixture (T: 30° C.±5° C.) (Example 9) In contrast, compacts with good material cohesion and high strength and density were achieved when the material mixture was heated to temperatures in the range of the melting temperature of the binder used (cf. Example 8), or preferably above it (cf. Examples 4 and 7). For instance, the compression may be performed with a mixture that has been heated to a temperature of 50° C. or more, preferably about 60° C. or more, or 80° C. or more. The binder is liquefied at temperatures in the range of the melting temperature of the binder used or above it and can therefore fill hollow spaces between the elastomer-containing particles and effectively wet and swell the particles and bind them to one another
b) Compression duration, temperature during demoulding (Examples 4 and 10-12)

Compacts were produced as described above in connection with Examples 1.6 by compression moulding (using an unheated mould) from the material mixture of Example 4, with the compression duration, and consequently the time available for the natural cooling of the material mixture in the press mould, being varied, as reported in Table 4 below. As a result, the temperature measured before the demoulding, also reported in Table 4, was varied.

The compacts, in so far as consolidated compacts were obtained, were examined as described above with regard to their strength, their material cohesion and their density. The results are also collated in Table 4.

TABLE 4

| | Ex. 4 | Ex. 10 | Ex. 11* | Ex. 12* |
|---|---|---|---|---|
| Compression duration | about 90 | about 60 | about 45 | about 15 |
| [min] | | | | |
| Temperature during | 30 ± 5 | 50 ± 5 | 65 ± 5 | 85 ± 5 |
| demoulding [° C.] | | | | |
| Material cohesion, | 5 | 2 | 0 | 0 |
| strength | | | | |
| Density D_{g} [g/cm³] | 0.84 | 0.66 | — | — |
| D_{g}/Dₛ | 2.2 | 1.7 | — | — |

*Comparative example

In the case of Examples 11 and 12 in which demoulding was performed at temperatures of 65° C. and 85° C., respectively, significantly above the melting point of the binder (54° C.), no consolidated compact was obtained. Rather, a powder remained after the pressing procedure, the state of which was essentially unchanged by the compression. In contrast, as can be seen from Table 4, consolidated compacts composed of a crosslinkable material according to the invention were obtained when the demoulding was performed at lower temperatures, for instance below 60° C. (cf. Examples 4 and 10) This indicates that, when the material mixture used is heated for the compression to a temperature at which the binder is liquefied, such as in these examples, cooling to a lower temperature may be appropriate before demoulding so that the binder can solidify again, in order to create sufficient cohesion between the elastomer-containing particles. Particularly advantageous properties of the compact in terms of good material cohesion and high strength and density were achieved particularly at demoulding temperatures below the melting point of the binder used (cf. Example 4), for instance at ambient temperature.
c) Compression factor (Examples 4 and 13-15)

Compacts were produced as described above in connection with Examples 1-6 by compression moulding (using an unheated mould) from the material mixture of Example 4, with the material mixture being compacted by a compression factor that was set differently in each case, in that the spacing (h) between the planar die surface of the compression die that comes into contact with the material mixture and the planar bottom surface of the cylindrical cavity was varied and was a) 26 mm (Example 4), b) 39 mm (Example 13), c) 52 mm (Example 14) or d) 65 mm (Example 15).

The compacts obtained in this way were examined as described above with regard to their strength, their material cohesion and their density. The results are collated in Table 5.

TABLE 5

| | Ex. 4 | Ex. 13 | Ex. 14 | Ex. 15 |
|---|---|---|---|---|
| Material cohesion, strength | 5 | 3 | 2 | 1 |
| Density D_{g} [g/cm³] | 0.84 | 0.67 | 0.50 | 0.40 |
| Compression factor Z | 2.6 | 1.8 | 1.3 | 1.1 |

As illustrated by Example 15, it is possible according to the invention to produce compacts composed of a crosslinkable material even at a comparatively low compression factor of slightly greater than 1.0 Nevertheless, the material cohesion, the strength and the density of the compact were low in this case. In contrast, compacts having increasingly greater material cohesion and greater strength and density were obtained at a greater compression factor (cf. Examples 4, 13 and 14). Particularly advantageous properties of the compact in terms of good material cohesion and high strength and density were achieved particularly when the material mixture used was compacted by a compression factor of >1.4 (Examples 4 and 13), in particular of >2.0 (Example 4).

### Variation of the Elastomer-Containing Powder (Example 16)

It is possible according to the invention to use material mixtures based on any desired elastomer-containing powders or pelletized materials. By way of example, according to Example 16, a material mixture was produced by the procedure described above in connection with Examples 1-6, except using an SBR rubber powder instead of the elastomer-containing powder composed of used tyres. For this purpose, the starting materials listed in Table 6, in the reported amounts, were mixed in a Hauschild SpeedMixer DAC 400 mixer (Hauschild GmbH & Co KG, Germany) at high mixing speed (1800 rpm) to form a homogeneous material mixture. The material mixture was heated here to a temperature of 85° C.±5° C.

TABLE 6

| | Ex. 16 |
|---|---|
| Component | Amount [phr] |
| SBR rubber powder⁹ | 100 |
| Binder² | 3 |
| Oil³ | 12 |
| Sulfur⁴ | 0.8 |
| Zinc oxide⁵ | 1.5 |
| Stearic acid⁶ | 0.5 |
| CBS⁷ | 0.8 |
| TBzTD⁸ | 0.2 |
| Bulk density Dₛ [g/cm³] | 0.42 |

⁹Vulcanized SBR rubber powder, commercially available from Roth International

The determined bulk density of the mixture obtained in this way is also reported in Table 6.

A compact was produced as described above in connection with Examples 1-6 by compression moulding (using an unheated mould) from the SBR-based material mixture obtained, and said compact was examined with regard to its properties.

The compact obtained had a relatively high density (0.89 g/cm³). It also featured a high degree of strength and very good material cohesion (evaluation of 5 on the abovementioned scale of 0 to 5 used).

### Production of Shaped Bodies Composed of Crosslinked Elastomer Compounds

Shaped bodies can be produced from the produced compacts composed of crosslinkable material according to the invention by vulcanizing the crosslinkable composition to form an elastomer compound, where-in contrast to the pulverulent starting mixtures-shaping tools, such as those otherwise used for processing raw rubber-based feed materials, can advantageously be used without difficulty.

This is illustrated by way of example in the present case using the example of compacts produced from the above-described material mixture according to Example 4, compared with a further processing of the pulverulent starting material mixture to form shaped bodies composed of a crosslinked elastomer compound

For this purpose, use was made of a heatable two-part press mould made of steel and consisting of a lower cylindrical body, having centrally on its upper side a hemispherical depression (diameter: 61.5 mm) as material receptacle, and of an upper pressure plate, having centrally on its lower side a hemispherical projection with a smaller diameter (57.7 mm) than the hemispherical depression and being able to be applied onto the lower cylindrical body in a centred manner via guides such that the hemispherical projection of the pressure plate engages into the hemispherical depression of the lower cylindrical body in a centred manner. Such a press mould is customary for the production of hemispherical shaped bodies, such as those used for instance for the production of balls, composed of raw rubber-based feed materials

In a first step, a compact composed of a crosslinkable material was produced from the material mixture according to Example 4 of Table 1 as described above. The compact was produced as described above for Example 4, with the exception that a press mould made of ASA plastic and having a cylindrical cavity of smaller diameter (40 mm) was used and the compression die for the compression by means of the press was brought into a position corresponding to a spacing (h) of 20 mm between the planar die surface of the compression die that comes into contact with the material mixture and the planar bottom surface of the cylindrical cavity.

To produce a shaped body composed of a corresponding crosslinked elastomer compound, the heatable two-part press mould made of steel described above was then heated to a temperature of 165° C. Subsequently, a) the compact produced as described above or b) the pulverulent starting mixture according to Example 4 of Table 1 was placed into the hemispherical material receptacle of the lower cylindrical body of the press mould. Subsequently, the upper pressure plate was applied onto the lower cylindrical body of the press mould in a centred manner via the guides and the filled press mould assembled in this way was introduced into a press (Lauffer RLKV 25/1), by means of which the upper pressure plate of the press mould was pressed onto the upper side of the lower cylindrical body until it was flush. The hemispherical projection of the pressure plate engaged in this case into the hemispherical depression of the lower cylindrical body in a centred manner and as a result compressed the material located between the two. The filled press mould introduced into the press was kept at the temperature of 165° C. for 18 minutes in order to vulcanize the crosslinkable composition. After cooling, the pressure plate was moved away from the cylindrical body of the press mould and the consolidated shaped body obtained by the pressing and vulcanizing operation that had a shape corresponding to half of a hollow sphere was removed.

Filling the press mould with the pulverulent starting mixture proved to be problematic in this case. When using the pulverulent starting mixture, it was necessary to overfill the hemispherical depression in the press mould in order to produce shaped bodies with the shape, defined by the press mould, of half of a hollow sphere having a wall thickness of 3.8 mm. This caused contamination to the working environment by excess powder and associated material losses. It would not be possible at all to create other geometries by overfilling the mould with the pulverulent starting mixture. In contrast, the production of the shaped body using the compact was possible without any problems. Transport costs and storage costs for the compacts are also significantly lower compared with the pulverulent starting mixture.

1. A method for producing a compact comprising a crosslinkable material, the method comprising:
(a) providing a mixture comprising:
(i) a powder or a pelletized material comprising at least one elastomer, and
(ii) one or more additives comprising at least one solid binder having a melting or a softening temperature (Tₘ) of 100° C. or less, and ethylenically unsaturated functional groups,
(b) compacting the mixture, that has been heated to a temperature of less than 120° C., using a shaping tool to form a compact, and
(c) demoulding the compact, after cooling, at a temperature of less than Tₘ in order to obtain the compact comprising the crosslinkable material.

2. The method according to claim 1, wherein the powder or the pelletized material comprises
at least one recycled elastomer,
wherein the powder or the pelletized material is provided by a method for recycling used tyres or parts thereof, and/or
wherein the at least one elastomer comprises a crosslinked natural rubber, a crosslinked synthetic rubber, a thermoplastic elastomer or a mixture or combination thereof.

3. The method according to claim 1, wherein the at least one binder has a melting or a softening temperature (Tₘ) in a range of 30° C. to 80° C. and/or wherein the at least one binder comprises ethylenically unsaturated functional groups.

4. The method according to claim 1, wherein the at least one binder comprises
at least a thermoplastic polymer,
a resin,
an ionomer,
a wax, or
a mixture or combination thereof.

5. The method according to claim 1, wherein the at least one binder comprises or consists of at least one polyalkenamer.

6. The method according to claim 1, wherein the mixture provided in step (a) further comprises
a crosslinking agent, and/or
wherein the mixture provided in step (a) further comprises
(iii) at least one polymer different from components (i) and (ii).

7. The method according to claim 1, wherein the mixture in step (b) is compacted by a compression factor of at least 1.2, and/or
wherein the compaction in step (b) is performed under conditions under which the solid binder is formable and/or flowable.

8. The method according to claim 1, wherein the mixture is heated to a temperature in a range of 40° C. to <120° C.

9. The method according to claim 1, wherein the demoulding in step (c) is performed at a temperature of 60° C. or less.

10. A compact, comprising:
a crosslinkable material obtainable by the method according to claim 1.

11. The compact according to claim 10, wherein the compact has a volume of less than or equal to 500 cm³ and/or a maximum length of less than or equal to 200 cm and/or wherein the compact is preportioned, wherein the compact has one or more predetermined breaking points and/or wherein the compact is in a form of a roll, coil, spindle or a layer structure.

12. A method for producing a shaped body, the method comprising:
(I)
(a) providing a compact according to claim 10, and
(b) crosslinking the crosslinkable material to form a crosslinked elastomer compound, or
(II)
(a) providing a feed material for a shaping tool, wherein the feed material comprises at least one compact according to claim 10 or one or more parts thereof,
(b) shaping the feed material using the shaping tool to form a desired shape, and
(c) crosslinking the feed material to form a crosslinked elastomer compound.

13. The method according to claim 12, wherein the crosslinking is carried out at a temperature in a range of 140° C. to 200° C. and/or for a time of 60 minutes or less, and/or wherein the shaping is performed by way of compression moulding, extruding or transfer moulding.

14. A shaped body comprising a crosslinked elastomer compound obtainable by the method according to claim 12.

15. (canceled)
